(19) United States
(12) Patent Application Publication
(10) Pub. No.: US 2007/0020604 A1
(43) Pub. Date: Jan. 25, 2007

(54) A Rich Media System and Method For Learning And Entertainment

(76) Inventor: Pranaya Chulet, New York, NY (US)

Correspondence Address: WHITE-WELKER & WELKER, LLC, P.O. BOX 199, CLEAR SPRING, MD, 21722-0199, US

(21) Appl. No.: 11/457,802

(22) Filed: Jul. 15, 2006

Related U.S. Application Data
(60) Provisional application No. 60/700,591, filed on Jul. 19, 2005.

(51) Int. Cl. G09B 3/00

(52) U.S. Cl. 434/350

(57) ABSTRACT

The purpose of the present invention is to offer distance-learning courses to students around the world by using the Internet. The courses offered will contain audio and/or video feeds showing the teachers teaching in a classroom setting, transmit the notes being made by teachers on a regular computer using a pen mouse or a tablet PC or on an electronic whiteboard as they teach, and also conduct quizzes for students. The students will be able to use the system interactively, including submitting responses to the quizzes and assignments, as well as accessing previously “broadcast” lectures of the courses.

### CROSS REFERENCE TO RELATED APPLICATIONS

This application claims priority from U.S. Provisional Patent Application Ser. No. 60/700,591, entitled “A Rich Media System and Method For Learning And Entertainment”, filed on Jul. 19, 2005.

### SEQUENCE LISTING OR PROGRAM

Not Applicable

### FEDERALLY SPONSORED RESEARCH

Not Applicable

### TECHNICAL FIELD OF THE INVENTION

This invention relates to a system and method for enabling distance learning over a multi-user network. More specifically, the present invention relates to delivering a traditional classroom learning experience over the Internet including an audio and/or video feed, computer based whiteboard content, and user-to-user communication. The invention can also be applied to multiple areas in the field of media and entertainment industries as described later in this application.

### DEFINITION OF TERMS

Live lecture: When a teacher is teaching and his image and/or voice as well as his teaching content is being transmitted live onto the clients.

Pre-recorded lecture: When there is no significant editing and a teacher's live lecture with all its contents is played in recorded version either via streaming content from central server(s) or by downloading them on the user's computer hard drive.

Pre-packaged lecture: When the teacher's lectures are recorded with all their content, then edited professionally before being uploaded on central server(s), and then played in recorded version either via streaming content from the server(s) or by downloading them on the user's computer hard drive.

### BACKGROUND OF THE INVENTION

Broadband in the North American market has grown beyond critical mass and is now in over 23 million homes. The percentage of households that have broadband in the US is over 18 percent and growing. The typical household with broadband access earns 27 percent more income and spends 52 percent more time online while being much more optimistic about emerging technology than households with dial-up access.

This broadband penetration is spawning multiple new rich media offerings on the Internet such as short movies, animation clips, previews of theatrical releases, commercials, television broadcasts, and downloads of traditional audio/video content.

The market for e-learing and distance learning offerings will strongly benefit and develop from this broadband penetration for many reasons. To begin with, educational content can leverage the customization abilities offered by the Internet much more than conventional media products since the resolution quality is relatively less important in the education videos, making them more conductive to web based distribution than any of the entertainment oriented offerings.

Students today are highly comfortable with computers and the Internet. Thus, rich media based learning over the Internet can help expand the education market substantially by offering consumers the ability to learn when they want and where they want.

What is needed is a method for offering educational courses delivered over the Internet that focuses on exactly replicating the traditional classroom setting rather than using the Internet and existing technology to merely relay the same information in a new format.

What is also needed is a method for offering tutoring services, available to students at any time to supplement the educational course offerings.

What is also needed is that this method be within the reach of individual teachers and tutors in order to best harness the creativity of the large number of people involved in the teaching profession. Thus, this method needs to be enabled over the Internet in a manner that allows teachers and tutors to find students outside of their immediate physical surroundings as well as teach them from any place as long as they have certain basic hardware such as a computer, a pen mouse, and an Internet connection.

What is also needed is that this method be affordable for the teachers and tutors. It needs to be priced in a manner that does not require them to make a large upfront investment in order to find students and/or start teaching them over the Internet.

It is a well-known fact that visual memory augments learning. The present invention is the only e-learning system that enables students to see the teacher's handwriting on the blackboard in real time, exactly as the teacher writes it. There are certain other systems that allow teacher's handwriting to be transmitted over the Internet, but they allow the handwriting to be visible only in a “choppy” manner as and when the mouse's left button is released. For instance, if the teacher slowly drew a long line on a whiteboard, these systems would make the line visible only after the whole line is drawn, while our system will show the line length increasing as it is being drawn. This makes the user's view of the whiteboard in our system exactly like the classroom experience.

Additionally, the present invention offers class notes exactly as they were written on the blackboard, which furthers reinforces learning by using visual memory. The present invention eliminates the distraction of taking notes, which, as teachers know, is one of the biggest hindrances to learning. The present invention solves this issue by offering class notes to students from the system's archives.

It is also an object of the present invention to enable students to learn anywhere, anytime thus eliminating the effort required on part of students as well as parents to ensure in person attendance in classrooms.

It is also well-known fact that shyness and “fear of appearing less intelligent” is one of the major reasons students do not ask questions in the class. This leads to a lack of understanding of fundamentals, which results in further diminished performance. It is therefore an object of the present invention to provide means for a student to ask a question either anonymously, without interrupting the lecture in case of pre-recorded or pre-packages lectures, or privately to a tutor.

It is also an objective of the present invention to provide a platform that offers teachers means for pre-recording lectures on basic topics and requiring the students to have watched them before they come to the class, thereby eliminating the teachers' need to go through basic content in class.

### SUMMARY OF THE INVENTION

The purpose of the present invention is to offer distance-learning courses to students around the world by using the Internet. The courses offered will contain audio and/or video feeds of the teachers teaching, transmit the notes being made by teachers on a regular computer whiteboard or on content pre-created in software packages like Microsoft PowerPoint, Adobe Acrobat, Microsoft Excel etc., and also conduct quizzes or give assignments to students to test and/or enhance their performance.

Teachers will make notes in their own handwriting using a pen mouse or a regular mouse or on an electronic whiteboard. Students will be able to use the system interactively, including submitting responses to quizzes and assignments, as well as accessing previously “broadcast” or recorded lectures of the courses. The system will also provide web-based tutoring services around courses being offered on our website as well as around other subjects of interest to students.

The present invention replicates the classroom environment to the closest extent possible on the Internet by synchronizing the display of white-board, various forms of electronic learning content, audio and/or video inputs, and providing a method of visual memory-based learning that eliminates the distraction of taking notes otherwise faced by students.

In case of live lectures, the lecturing teacher will answer queries in real time. In case of archived lectures, the system of the present invention will have trained teachers or tutors who will answer student queries queries. These teachers and tutors enable the system of the present invention to create a new paradigm where not only the teacher who runs lectures can answer queries, but even other teachers or tutors, after proper familiarity and training with the content, will be able to answer student queries. This enables the present invention to offer interactivity at all times in a cost effective manner.

The method and system presented frees interactivity from the constraints of location as well as time. While the locational constraint has been removed by other e-learning systems known in the prior art, where student can interact with the teacher from anywhere, no one else has removed the time constraint, i.e., the scheduling that the students and teachers need to do before they interact.

While the delivery of educations services and the system and method of e-learning is the best mode for the present invention, it is just one embodiment of this method. The system and method of the present invention can be easily adapted to a variety of audio, visual, and other content, and combined media delivery systems. One example given in more detail is a quiz show embodiment that allows a large number of online participants to participate in a question and answer session, where their performance is measured for its speed and accuracy, and, optionally, they can play along with a quiz show being broadcast on television or in an Internet-only version. The system and method of the present invention can be applied to the media industry in addition to the education industry by enabling more interactivity in television programs as well as movies.

### BRIEF DESCRIPTION OF THE DRAWINGS

FIG. 1a is a schematic diagram of the technology needs to enable the e-learning method of the present invention;

FIG. 1 illustrates the archive mode of the present invention;

FIG. 2 illustrates the live mode of the present invention;

FIG. 3 is a screen shot of a client application illustrating the electronic classroom display;

FIG. 4 is a screen shot of a client application illustrating a quizzing situation;

FIG. 5 is a screen shot of a client application illustrating a tutoring session;

FIG. 6 is a schematic diagram illustrating the physical hardware required to enable one embodiment of the present invention; and

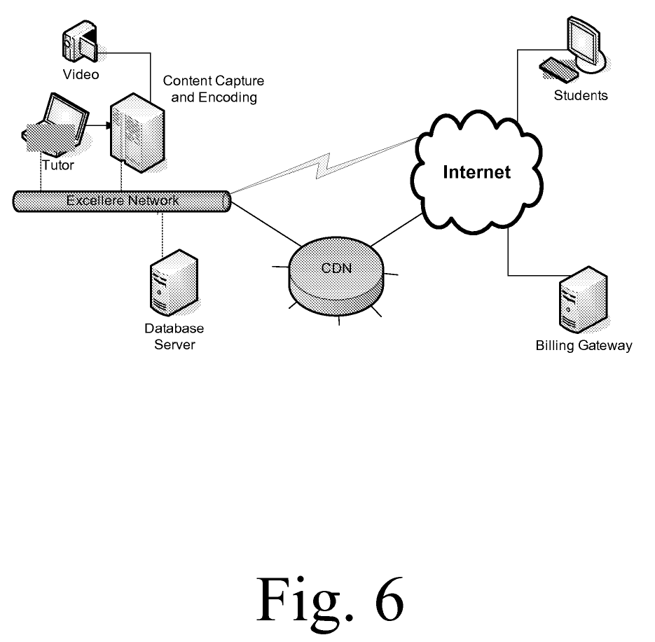

FIG. 7 is a screen shot of a client application illustrating a tutoring session.

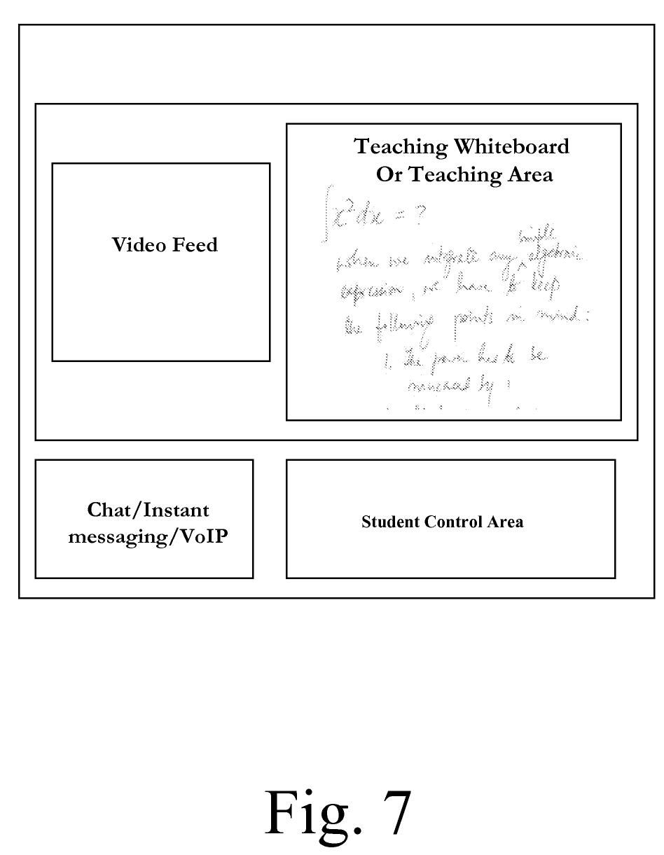

### DETAILED DESCRIPTION OF THE INVENTION

In the following detailed description of the invention of exemplary embodiments of the invention, reference is made to the accompanying drawings (where like numbers represent like elements), which form a part hereof, and in which are shown by way of illustration specific exemplary embodiments in which the invention may be practiced.

These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Technology Requirements

Referring to the figures, it is possible to see the various major elements constituting the apparatus of the present invention. The invention is a system and method for delivering electronic media content such as teaching materials for online education or, in case of entertainment, content such as games shows, news reports, interactive movies, or content for smaller and/or geographically dispersed audiences such as ethnic populations.

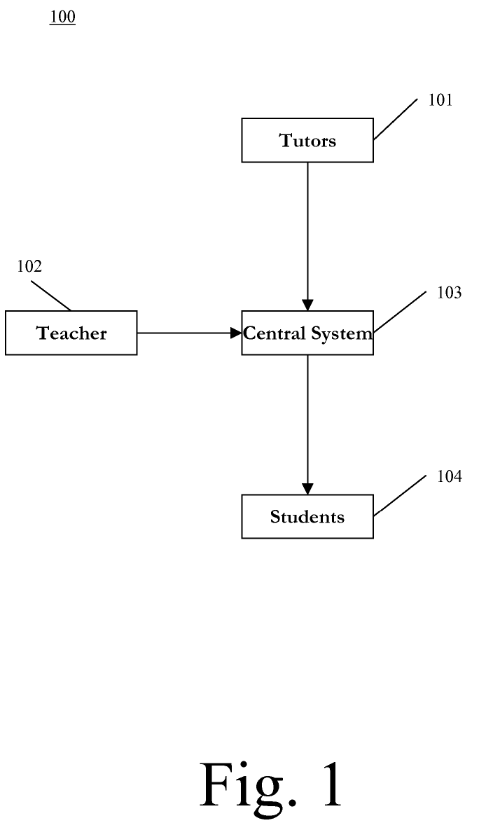

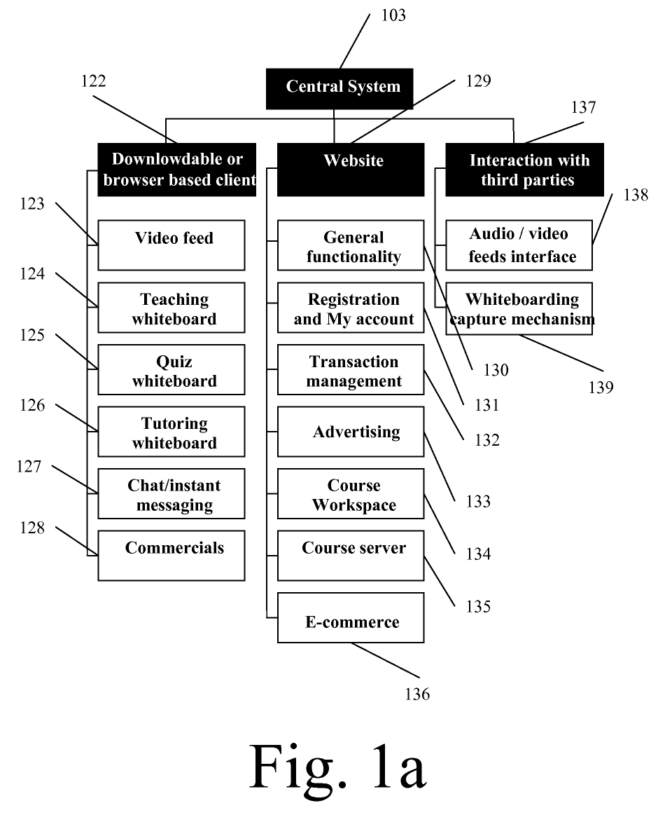

Now referring to FIG. 1a is a schematic diagram of the technology needs to enable the e-learning method of the present invention is shown. There are three kinds of roles of users interacting with the central system 103: Students 104, Tutors 102, and Administrators.

The software for individual students 104 desiring to use the present invention is likely to be either a downloadable or a browser based client software which interacts with the central systems servers. This software 122 is likely to be downloaded by a large number of students 104.

As shown in FIG. 1a, the software 122 will have an optional window for a video feed 123 and a section which will be like a whiteboard 124, where whatever the teacher writes on an interactive whiteboard/tablet PC will be displayed in synch when the teacher writes it and recorded and archived for later retrieval and review. The teaching whiteboard or teaching area 124 will have a one-way communication from the central systems servers to students' software 122.

In an alternative embodiment, all details of the teaching method described will still be applicable when the teacher uses other commonly used software packages such as Microsoft PowerPoint and Microsoft Excel instead of a whiteboard as a teaching device. In such cases, the teacher could use these and other similar packages in our system as a teaching device to further explain things to students by walking them through a presentation, in case of Microsoft PowerPoint, or a calculation, in case of Microsoft Excel. The teacher can also handwrite things on content created in any of these packages in order to further explain things to students.

The client application will also have other features which will be useful in course of lectures, such as a way to get user feedback during live lectures, electronic hand-raising mechanism, a way to applaud etc.

There will be a pre-scheduled broadcast time for live lectures. However, students will also be able to access any lectures from the system's archives later and they will always be able to pause, fast forward and rewind lectures based on their preference. However, the students would not be able to fast forward any commercials inserted as a part of the lectures.

During lectures, students 104 will also be able to mark the points where they have doubts so that they can later access and/or replay these specific points of course-content and get their doubts answered by a tutor 101 who can also access and/or replay these points. The student 104 will be able to achieve this by pressing a button that will be tracked for each student separately. The act of the student pressing a button to mark the point where s/he has a doubt would tag the video feed and associated feeds received by the client application so that they can be later replayed for the student 104 and the tutor 101. This way, when the students immediately or later discuss the doubt with their tutor, the tutor 101 will be able to access exactly the point of doubt and play it back to the student.

The video feed 123 and teaching whiteboard or teaching area 124 of the screen will get replaced by a quiz whiteboard 125 containing the content for quizzes (e.g. in a multiple choice format), when the students 104 have to take a quiz. The quiz whiteboard 125 will have a two-way communication between the central system's servers and students' software in order for them to be able to answer the quiz questions and get feedback.

The students 104 will have to submit their answers within a pre-defined period of time by clicking on one of the radio buttons provided against the multiple choice answers for each question—the system will have already defined correct answers in the central system's database, so the software will automatically check students' answers and give them individualized results while comparing them with those in their peer group who have taken that quiz till then.

After the time for a quiz is over and the results are displayed, this area will switch back to the video feed and teaching whiteboard or teaching area where the teacher's notes will start appearing again as s/he starts writing it in the video. This synchronization, between what the teacher is saying in the video feed and when the interactive whiteboard should switch to a quizzing whiteboard and vice versa, can be achieved by keeping a record of time-codes in video feeds and feeds into the interactive whiteboard and quiz whiteboard.

Students 104 will be able to skip quizzes and assignments in which case there will be a “skipped” entry against their name in the database that collates results of all students 104 who have taken quizzes.

The same software will also be usable for tutoring sessions with tutors 101 who will not be running any course per se. This feature would be used for providing a tutoring service where students 104 would be able to ask questions from tutors 101 on specific doubts they develop as a part of their courses or even independent of any course provided on the website. The central system's tutors 101 will be sitting in remote locations and they will have an interface of their own. The central system will have a number of tutors 101 available for each course, and these tutors 101 would be available to students 104 based on the course they are taking. Instant messaging, VoIP, and conventional telephony will be offered to help the student effortlessly access the tutor in the middle of their session or later. The student will be able to either declare to a pool of tutors that they are looking for help, or contact their chosen tutor. For the tutoring service, students 104 will be charged a pre-determined rate per minute and money would be debited from their accounts, and a record will be kept of these transactions. Students 104 will be able to mark their favorite tutors, like people designate buddies on the other instant messengers they use.

Whenever a student 104 is discussing a doubt with a tutor 101, there will also be a section of the screen 107 where the student 104 will be able to chat with the tutor 101. This chat will be in the form of an instant messenger that the student 104 will also be able to use with their friends who have it downloaded. As mentioned earlier, students will be able to keep track of their favorite tutors as “buddies”. This section could remain visible even as the student/tutor toggle back and forth between the tutoring whiteboard 126 and the video feed 123/teaching whiteboard or teaching area 124 views. This would enable the student 104 to continue chatting in either of the views. The students 104 will also be able to talk to tutors 101 through VoIP as well as conventional phone calls. The amount of time spent by the tutor and the student in solving the students' doubts will be tracked by monitoring the duration of their conversations, chats, and/or white boarding sessions.

In an alternative embodiment, the system could have commercials 128 appear in the video feed section 111 during breaks in the lectures.

The central system 103 will assign a default size to a student's screen for each of the sections mentioned above (e.g. video feed, teaching whiteboard, tutoring whiteboard etc.). However, the students 104 as well as the tutors 101 using the software 122 will be able to maximize the relative size of all these screen sections. Also, the students 104 will be able to entirely turn off the video feed if they want, but the audio will still continue in synch with what is being written on the whiteboard.

Through a standard website interface 129, general functions 130 known to similar e-learning systems and other websites will enable students 104 to create a log-in and password, and provide demographic information etc. while registering their account 131. There will also be an optional section, where the user can key in their credit card information and more demographic information. This section will also have email functionality, so that students 104 as well as teachers 102 and tutors 101 can receive and send emails. All emails will also be forwardable to users' external email accounts. This section will keep track of all courses the students have done, and keep a record of their overall and quiz specific grades. This section will also contain scheduling functionality using which students will be able to schedule time with tutors.

A transaction management component 132 will be activated once the users enter their credit card information, and their account will be billed for the lectures as well as tutoring sessions they take. The person paying the bill in case of minors will be the parent, who will have their own login that will be linked to their child's account with certain features such as academic performance and progress visible to them. There will also be an option where parents will be emailed a monthly statement for all transactions including lectures, tutoring sessions, other purchases etc.

The website 129 could also allow selective access to the course content on our website. For example, if a course has multiple lectures, the website 129 might allow students to buy lectures on a one-on-one basis.

In an alternative embodiment, advertising 133 can be placed or added to the video feeds 123.

The website 129 will also include a course workspace 134 comprised of a course home page—that describes the course content, help and FAQs for the course, and course schedule, a forum/bulletin board type structure where teachers 102 or tutors 101 can send messages to all students 104 in a course. Students 104 will also be able to send back messages to the central system 103. The website will also record the latest results of all quizzes and assignments, including the number of students who have submitted responses, their scores etc.

A course server 135 will serve up all elements of a lecture including AV feeds, graphics, questions and possible answers as well as any associated advertising 133 to each student 104. It will also receive all responses and perform all data analyses associated with administering a quiz/an assignment. The course server 135 will coordinate all elements of a lecture, including host video feeds, other video feeds, quiz questions, quiz responses, email server, and advertising feeds. The course server 135 will also do all calculations relating to the students' performance vis-à-vis their peers in a quiz and provide input on customized feedback to students 104, based on the questions they got wrong. The course server 135 will be able to serve up all previous lectures and associated content.

The E-commerce component 136 of the present invention will include the selling of books, DVDs and other material associated with each course. This material will be accessible from the client application as well as reachable directly on the website 129. If buyers have not provided their credit card information already, they will be needed to do so at the time of purchase. The system will also sell copies of a teacher's handwritten notes as well as their typed up version.

An interface 137 which will coordinate the dispatch and receipt of audio-video (AV) feeds 138 with an external network that specializes in carrying rich media data over the Internet might be used as well. This interface 137 will provide the AV feeds 138 associated with any specific user session to an external network, and receive it back from that network to display in the client application for the user.

A white boarding capture or screen capture mechanism 139 will be used to record what the teacher 102 writes on an interactive whiteboard or a tablet PC or using a pen mouse or regular mouse at the time of teaching. The white boarding or screen capture mechanism 139 will capture all these signals and play them, in synch with the teacher's video or voice when a student 104 watches the lecture. The white boarding capture mechanism 139 will also capture all notes that the teacher 102 writes on the whiteboard in the form of image files of notes that we will sell through the website.

Archived Mode Embodiment

Now referring to FIG. 1, in the archive mode 100, the present invention consists of a central system 103 that enables tutors 101, teaches 102, and students 104 to connect electronically over a multi-user network such as the Internet. In archive mode, a Teacher 102 records the AV portion of the course and designs all quizzes, assignments, time schedule and other course content within the central system 103. Tutors 101 are then available to answer students' specific queries through a combination of white boarding, instant messaging and VoIP communications techniques via the central system 103. Students 104 watch the archived lectures at their convenience by connecting to the central system 103 and solve any doubts they have by interacting with tutors 101 again via the central system 103. This mode can be extremely powerful in enhancing students' learning because it replicates the classroom environment—the synchronized combination of a teacher's AV input and their handwritten content being generated on the whiteboard helps make the learning more effective for the students.

This archived mode can be used to develop extremely adaptive learning courses which can be used to enhance the student's performance by focusing on their weak areas. In order to accomplish this, the subject of the course, let's say high-school math, will be broken into a skill and sub-skill hierarchy that the student needs to learn. All course content including teacher's audio and video, typed up and handwritten notes, practice questions and quizzes will be developed based on this skill hierarchy. Then, the system can diagnose a student's weak areas, and serve them with content that helps them strengthen these areas. As the skill hierarchy can be developed at varying levels of granularity, such archived courses could be very powerful in helping students build their fundamental understanding of any given subject. In essence, this will be a more structured and more cost-effective way to achieve what teachers achieve when they teach students on a one-on-one basis, identifying and strengthening their areas of weakness in a given subject. As the content of the archived courses is well structured around a skill hierarchy, it is also easy to offer completely customized courses specifically focused on only those areas where they need help. The system can also administer exercises of gradually increasing difficulty so that the students gain expertise in desired areas at a more manageable pace.

In addition to focusing on the student's weaknesses in the skills hierarchy, the archived content can also be made adaptive in other ways. E.g. In case of multiple choice questions, the system can have the teacher pre-record specific content associated with each of the answer choices of these questions. Later, when a student is answering these multiple choice questions, the system can play for them the specific files associated with their chosen answers. This way, whenever the student makes an incorrect choice, they can learn where they went wrong, almost as if they had a live teacher giving the explanations to them. The same concept can also be applied to open-ended questions, where a student can choose to play the explanation for any specific question.

In another embodiment, the central system 103 can be combined with already published content or publications to offer the publisher's content to the multi-user network. Potential publishers will include textbook/electronic publishers and test prep market players. Publishers will find a major additional revenue stream for their already published content since students often spend much more on tuition fees than they spend on books. Additionally, the central system will receive highly acceptable and desirable content by offering teaching content around the most popular publisher titles.

Based on the thought that students get real value from a textbook often by being taught its contents by a teacher, an additional offering of the present invention will include teaching sessions covering content of specific textbooks where an interactive classroom experience will be available to a student who wants to go through any part of a textbook at any time.

In this embodiment, the teacher 102 “teaches” a whole textbook or publication from an established publisher and also gives assignments etc. the way s/he would have given them in a traditional class setting and the tutors 101 are trained on the teacher's lectures, and are equipped to answer students' specific queries. Students 104 may go through the entire textbook via the central system's platform and to solve any doubts they have, interaction with Tutors 101, will be available as previously described.

Detailed Illustration of how this Embodiment can be Used to Developed Archived Educational Content which is Adaptive in Nature

A detailed example of how archived course might be developed in the above mentioned embodiment is provided. This illustration explains how archived educational content can be developed for school going students using the system of the present invention.

Each grade will have a certain set of subjects and there will be a set of tables, which could store the information about a student's grade, state, and academic performance in each subject based on the initial questions that we ask. Each subject could have multiple modules. When a student signs up in any subject, he will get a unique course ID. Each course ID could have multiple modules, each module will comprise of skills, each skill will comprise of sub-skills. The system will store a relational table that will tell us what are the module-skill-sub-skill combinations needed for each grade-state-subject-marks combination for any student. The system may also have customized courses, which could be made by picking selective skills in various modules depending on an initial diagnostic test in any subject: in this case, system will have a relational table above that links student performance in various sections to the module-skill-sub-skill combination that the student needs. Each module will have certain core classes (CCs). AV files will be developed for one sub-skill at a time—for the CCs, the system will feed in the sequence in which the sub-skills are covered. Each CC will cover one or more skills, which in turn will be made of sub-skills. Each class will include theory, practice questions and a quiz at the end. Theory will consist of AV files which will play the teacher's voice, video and/or handwriting in a synchronized manner and practice questions will consist of pop ups and linked to various sub-skills.

As said above, there will be pre-determined practice questions at the end of each sub-skill-hence, a sub-skill will be a combination of theory and practice question set (PQS) 1 and PQS 2 for repetition if needed. The questions in PQS 1 and PQS 2, and the sequence in which these questions appear will be already marked in the question bank.

There will be a pre-determined quiz (PQ) 1, a PQ 2, and a PQ 3 at the end of each class. Each PQ 1, PQ2 and PQ3 will be 20 minutes long. All questions will be timed. The student will always be able to get explanations of his mistakes by playing of flash files which can be played by pressing a button—each question's each choice will have a flash file, and only that file will be played which is associated with the choice that the student made, whether right or wrong there will be a file even for the correct choices.

For each PQ, once the student finishes all questions, a voice file will play asking him to check his results, and then another one will play in which he is told how he did before his results are displayed. The voice file that plays for checking results will be one of twenty randomly associated files, the voice file that plays before his results are displayed will depend on what his result is but again it will be one of several files that can be played from the database so that the student does not feel he is hearing the same recorded voice over and over. The button for explanation will be displayed against each question in the result of the PQ.

For each of the questions in PQS and if the student is generally practicing more questions, the associated flash file will automatically play when the student submits the answer. The student will be able to pause, fast-forward, and skip to the next part of the lecture at any point, including when an explanation is playing for any question in PQS. The next part will be next PQS, next sub-skill or PQ whichever comes first.

If a student does not pass PQ 1, the system will see in which sub-skills he is not above the pre-determined proficiency level. He will asked to replay the parts of the CL that were related to those sub-skills along with their PQS2s. The student will then be asked to take questions from PQ2 at the end of the replay. If he does not pass it again, he will be recommended to take “basics classes” (BCs) that cover the “basic” sub-skills that the quiz questions are based on. If the student clears the BCs, then he will be asked to take PQ3—if he still does not clear it, he will be recommended to repeat the sub-skills that he failed and practice more questions in it, and will be advanced to the next CL.

Initially, BCs will be chosen from amongst CCs, but later, BCs could be generated on the fly based on the sub-skills that the student fails. Later the system will insert a “practice more problems” link at the end of each PQS and PQ. There will always be an “Ignore recommendation and go further in my original course” link when we recommend BCs or parts of CCs that need to be repeated

Each skill could be a part of multiple modules, each sub-skill could be a part of multiple skills. Each sub-skill could have up to 10 sub-skills as “basics” upon which a student builds that sub-skill. There will be a multiple choice question bank that will feed PQS 1, PQS 2, PQ 1, PQ2 and all other question-answer exercises. Each question in the question bank will be associated with multiple sub-skill(s). Each question and each of its choices will have associated recorded voice files and flash files

Overall System Modules in the Above Illustration

The system could have the following modules to enable the creation and offering of educational content described above:

Student profiling: an initial set of questions that help us assess what the student needs (based on his grade, state, and marks).

My courses section: including modules, links to classes within those modules, history in terms of classes taken, quiz questions and quiz performance of the student.

An administrative section that can facilitate the creation of archived educational content is a very efficient manner by giving administrators the ability to perform the various functions. Via input modules, skills and sub-skills are defined with their hierarchy based on the rules in the previous pages. Link skills and sub-skills to each class are also offered. Administrators can also input questions and their multiple choices and declare the sub-skills they are associated with as well as assign questions and their order in the PQS 1, PQS 2, PQ 1, PQ2 and PQ 3. Flash files with sub-skills' theory part, or with individual choices from the multiple choices within questions can also be uploaded and associated with the questions and answers.

For each module, the ability to upload 20 different flash files asking the student to check his results in a PQ in addition to 20 different flash files for informing the student that he has passed, and 20 different files informing him that he has failed. Defined pass-fail marks that will apply to various PQs are utilized.

Parents will also have access to the info in students' my courses section, except that they will not have access to classes. A student will get access to classes only when he goes through the previous classes depending on the recommended order in a module or course-otherwise, he will see the class names but not be able to take them. The system will create a diagnostic test and a final test at the end of each module. If parents are the one paying for the course, they will be apprised of the student's performance after each lecture. They will be able to turn these reminders off.

The system will have a recommended schedule for the lecture which can be modified by whoever pays for the course—the student as well as the paying person will receive reminders about what they should do each week, and reminders if they are running late. At any point in any session, except a quiz and a test, the student will be able to ping a tutor using either other instant messaging solutions or our own downloadable software.

Live Mode Embodiment

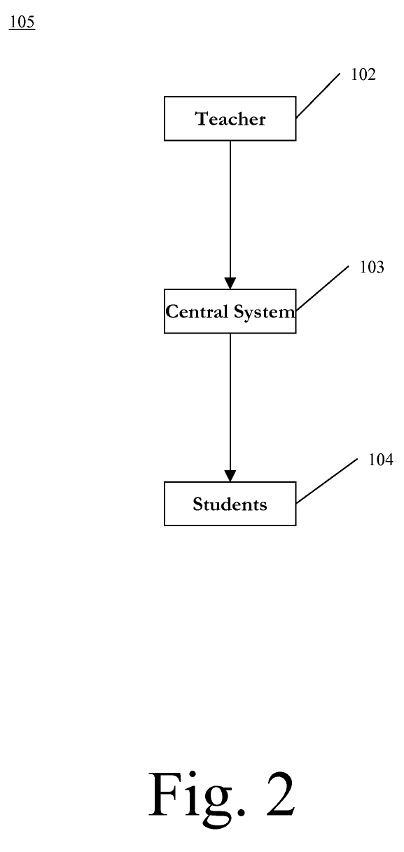

Now referring to the live mode 105 of the present invention illustrated in FIG. 2, teachers 102 conduct live telecasts of their lectures and answer any student queries themselves during the lectures via the central system 103. The students ask questions via chat or by speaking through a conventional phone or VoIP mechanism depending on when the teacher allows them to speak during the session, the teacher answers their question by writing on the whiteboard or on other teaching content being used and explaining further by speaking as the teacher would in an offline classroom. The lectures are archived automatically by the central system 103 for replay later as well. In live mode, students 104 attend lectures on defined schedules, but they can also go through the lectures in the archived mode previously described as well, where their doubts can be answered by tutors 101 instead of directly by the teacher 102 via chat and voice. Like the archived mode, this mode also reinforces the student's learning due it its synchronized combination of a teacher's AV input and their handwritten content being generated in real-time on the whiteboard.

In a manner similar to the archived mode above, the live mode can also be used to offer educational content and services around textbooks and other content published by publishers.

Closed System Embodiment

In its most basic form the present invention is a “closed system” which allows the administrators to retain complete control over the course material and to produce and shoot the courses themselves while using teachers who design and deliver the course content. In another embodiment, the present invention will adopt a more “open system”, where it will offer teachers around the world the ability to conduct their own teaching sessions over the Internet.

In the initially implemented “closed system”, some of the functionality elements mentioned below will not be needed. They will primarily be the features that help teachers in designing and offering their own courses from wherever they are in its most basic form, the present invention will include one or more pre-packaged courses. As the system moves closer to the “open market” phase, it will also include live lectures that will involve minimal editing.

Creation of high quality content is much easier and very effective in the method and system described since it can be done in almost real time by the system of the present invention. The system is an improvement over currently known e-learning systems as it eliminates much of the time necessary to generate a new course. In the present invention, the teachers simply write on the electronic whiteboards or using their pen mouse and speak, and an e-learning-based course is created, resulting in significant reduction in time as well as monetary investment needed.

Open System Embodiment

The open system embodiment is something novel and non-obvious as no prior art teaching discloses a method, system or, service for providing a free market for teaching services, where teachers can offer courses or tutoring services in any area they wish, students can sign up for any courses or tutoring services they want, and students can rate teachers. The market will be self-governing as teachers who perform well will be rated highly and students will prefer their courses and services rather than those offered by other teachers. For the archived or pre-recorded content offered by the teachers in this embodiment, their offering can still be made more powerful by maintaining the complete interactivity at all times using tutors trained on courses offered as discussed.

In an open system embodiment the central system 103 could act as an intermediary, taking a share of the revenues generated by the teachers' 102 offering courses. In the open system embodiment, teachers prepare their own course content to offer and conduct live web casts of their courses or tutoring services. Teachers 102 also answer questions from students during the lecture, as described for the live mode 105 above. These live web casts could be recorded for replay at a later time as well. The content could also be recorded, packaged, and offered by the teachers in an archive only mode, with the option of providing tutors 102 in the archive mode 105, again as previously described in the live mode 105 above. In this embodiment, the teacher will in essence become a “producer” of educational content that is offered to students in an on-demand format.

The open system allows students 104 to choose which teachers' courses they wish to take based on their needs and past students' ratings of the teachers. Students 104 attend the teacher's lecture on a defined schedule or they can go through the lectures in archive mode, receive help from either the teacher in live mode 105 or a tutor in archive mode 100.

In the open system structure, teachers will be able to decide on all the parameters of the course, including the number of students allowed to register, students' ability to ask questions via phone or VoIP or chat, fees for the course structure etc. A teacher 102 might be provided a starter kit, which will be available on rent/lease/sale/for free, and will comprise of a professional or consumer digital video camera, an interactive whiteboard/tablet PC/pen-mouse, and/or a setup guide which tells teachers 102 how to set up their teaching location which could even be a real classroom and how to use the central system 103.

In an alternative embodiment, a live-open system could initially be audio based as opposed to having a teacher's audio and video, due to bandwidth constraints.

The open system embodiment aims at making an e-learning platform more accessible to teachers anywhere, is the first system that is totally affordable for them, and helps students and teachers of any subject find each other.

The open system harnesses the creativity of teachers and potential teachers to create and teach courses in any areas of their choice. Not only can the system of the present invention be used by teachers of more common subjects/areas, such as high school math, science etc., but the open system establishes the possibility for students and teachers/potential teachers of highly specialized areas to find each other. For example, a highly specialized college professor who teaches a course in fiber optics or photo-mechanics or a real estate agent who runs a class on the process of buying an estate in a specific state will experience less difficulty in finding students interested in taking their class offerings by using the system presented.

Potential Embodiment Combinations

The following matrix summarizes the potential combination of embodiments possible with the present invention from the perspective of a teacher.

| | Live | Archived |
|---|---|---|
| Closed | | |
| Open | | |

In the closed system embodiment, the present invention offer many unique solutions such as interactivity to solve students' doubts at any point in time, a better white boarding experience over existing systems, potential partnering with publishers to launch courses around their textbooks, notes in teachers' handwriting, and the ability to administer quizzes and display their results.

With respect to the open system embodiment, there is no suggestion, motivation or teaching in the prior art resulting in a complete novel and non-obvious system and method. The open system also offers all of the unique elements of closed system described above.

In case of archived lectures, the system solves the problem of latency by achieving interactivity without any latency multiplication by giving the users the downloading option for the course content. This helps students achieve very low or zero latency irrespective of the speed of their Internet connections. For minimizing latency or enable offline sessions, the present invention enables a student to pre-download courses on a students' hard drives so that the student do not have to received content streams from the system's servers over the Internet when they attend lectures. Students will still be able to take quizzes and receive feedback based on information on other students' performance on quizzes that is either given to them by the system's servers if they are online or downloaded to their computers if they are offline. If they are offline, the information on a particular student's own performance will be uploaded back to the system's servers the next time they are online. For those students who prefer minimal disk space consumption over low latency, the same courses will be available through streaming media from the system's servers as well.

In case of live lectures, the problem of latency in interaction is solved by giving teachers and students the option of using regular phone lines if they wish. Otherwise latency could become worse—because of people at both ends interacting, effective latency could be doubled if there is a delay on each side.

Also, at a later stage, the present invention will also provide a completely non-downloadable or browser based version of the system of the present invention for students who wish to take the courses directly from any computer connected to the Internet at any location, or for those students who do not want to download any software on to their hard drives.

Electronic Classroom Display

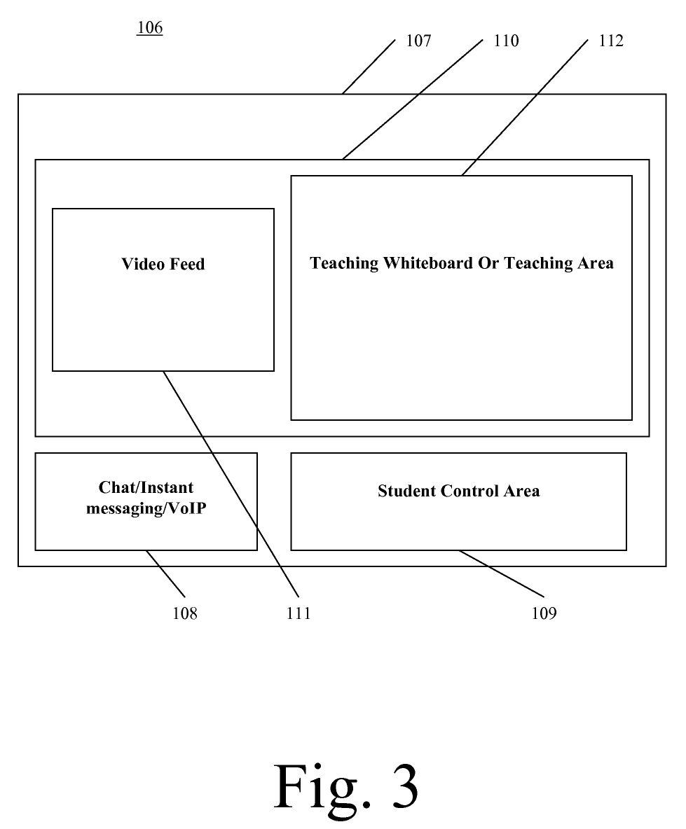

Now referring to FIG. 3, a screen shot 106 of a client application 107 illustrating the electronic classroom display of the present invention is shown. The client application 107 has a section 110 that replicates the audio and visual aspects of a traditional classroom by providing a video feed 111 for providing the student with an audio and visual classroom experience of the teacher teaching in a classroom. When viewed in archive mode 105, the ability to pause an archive lecture at any point and get a doubt answered by a tutor 101 is available to a student 104. The system will also have the capability to allow students to pause a live lecture if they want, and resume watching the lecture when they wish.

The main section 110 also includes an electronic whiteboard or a teaching area 112 that replicates what a teacher would write on a traditional blackboard. One unique feature of this system 112 is that it provides for perfect synchronization between the audio-video feed and white board or teaching area content. The teaching area could also have content from software packages such as Microsoft PowerPoint or Excel as a background instead of a plain whiteboard.

The client application 107 also includes secondary windows 108 and 109 for providing additional features. For example, one secondary window 108 can be used to provide chat and instant messaging services, while another second secondary window 109 can be used as a control panel where students can access additional features of the system 103 such as toggling between different whiteboards, marking points of doubt, or accessing additional account links.

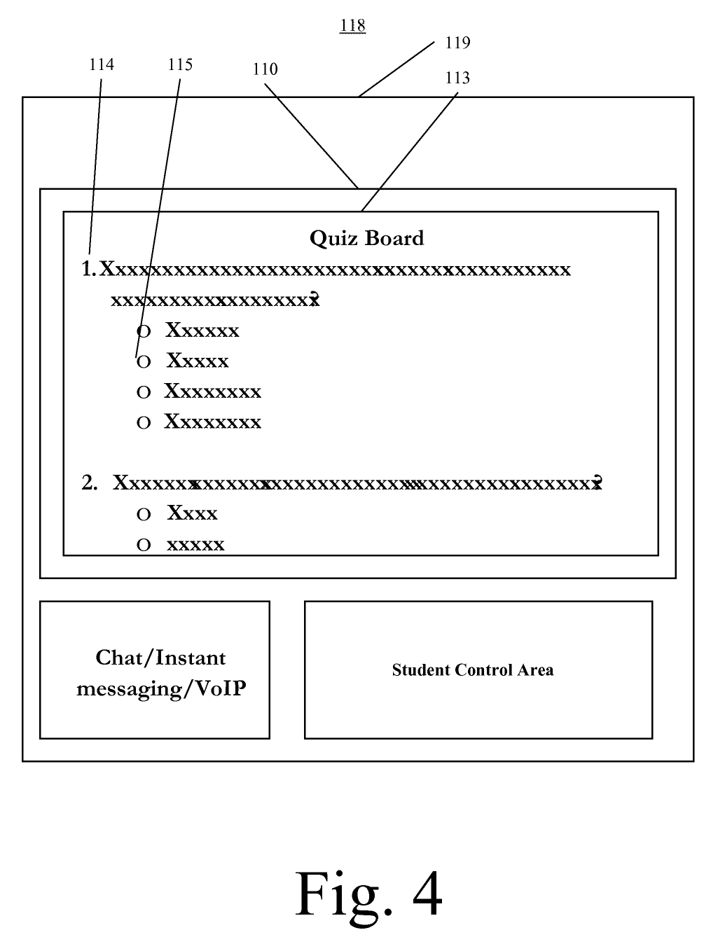

Additionally, quizzes, assignments and interaction between teachers, tutors and students can be accomplished through the use of the main section 107, teaching whiteboard or teaching area 112, and secondary windows 108 and 109. Now referring to FIG. 4, a screen shot 118 of a client application 119 illustrating a quizzing situation is depicted. Here, the main section 110, is no longer divided into multiple windows, but one large window 113 which graphically provides the student with the written questions 114 and answer choices 115 for a given quiz and allows for selection and/or submission of an answer.

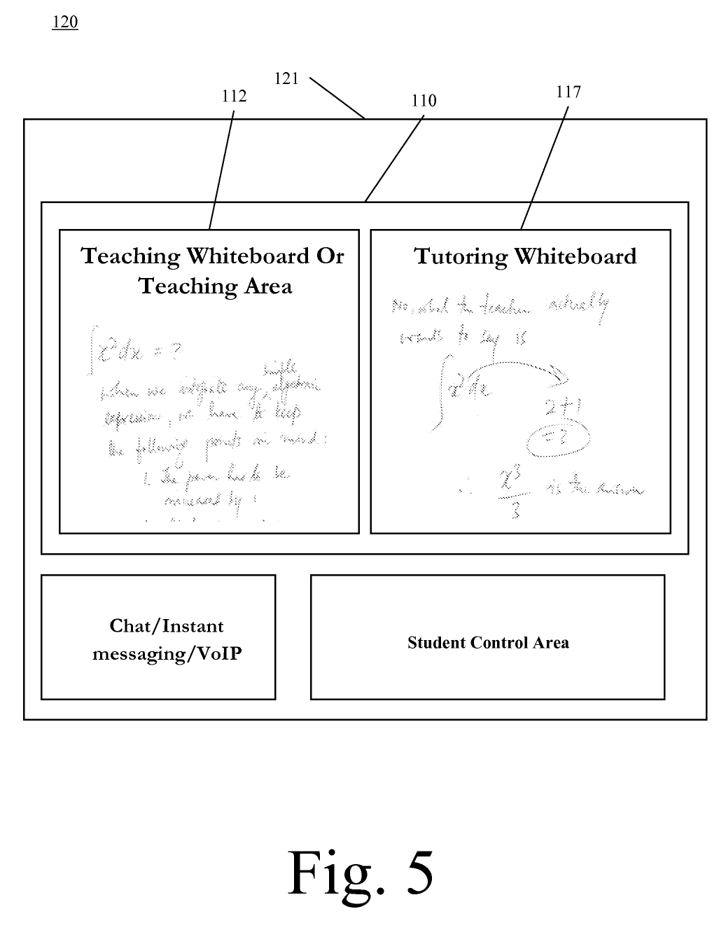

Now referring to FIG. 5 a screen shot 120 of the client application 121 illustrating a tutoring session is shown. In a typical tutoring session the main section 110 could remain divided into two windows, one for the teaching white board or teaching area 112 and a second tutoring whiteboard 117. Alternatively, the student and the tutor could toggle back and forth between the teaching whiteboard/area and the tutoring whiteboard, as described above.

The students 104 will interact with tutors 101 by a combination of a tutoring whiteboard 117 and instant messaging/chat/VoIP/regular phone 108. The tutoring whiteboard 117 will replace the video feed 111 as well as the teaching whiteboard or teaching area 112 section of the screen and offer a two-way communication between students 104 and tutors 101 using an interactive whiteboard. The tutoring whiteboard 117 is visible to both the student 104 and the tutor 102 at the same time. However, if in the middle of a tutor 101 solving a student's doubt, if either the tutor 101 or the student 104 wants to reference the video feed 111 and the feed into the teaching whiteboard or teaching area 112, they will be able to switch back to those feeds and watch them and then toggle back to the tutoring whiteboard. In such cases, the other party's software could automatically get toggled in synch as well. In other words, both the student 104 and the teacher 102 could have a session of the video 111 and teaching whiteboard or teaching area 112 feed running, but paused, while they are discussing the student's doubt through a tutoring whiteboard 117.

In this example the video feed window 111 has been removed, but it should be appreciated that the any combination of windows may be retained or that a paneling or windows may be used to enable a student 104 to toggle or switch been widows as desired to either view the tutor whiteboard 117 or teaching whiteboard or teaching area 112 or to replay a part of the teaching lecture.

Next Generation Game Shows Alternative Embodiment

In an alternative embodiment a new genre of game shows/reality shows that can be launched by using the same technology used for the education oriented application described earlier is disclosed. While the information in the following paragraphs provides one example of such shows, many different show formats and concepts can be designed and launched using the same fundamental principles that have been used in designing the example provided.

One potential alternative embodiment of a game or reality show combines game play of a traditional television quiz show with massively multiplayer online gaming (MMOG), allowing thousands, if not millions, of online contestants to participate in the game along with the contestants in a television or radio studio. Television and MMOG is an extremely lucrative combination as they feed on each other and the results on a subscriber base can be explosive. For example, the success of online poker was driven by televised poker shows on ESPN.

The game is played according to the following basic rules:
A. There are one or more contestants, preferably six, in the studio
B. The studio contestants as well as a plurality of contestants connected via the Internet or other multi-user network are measured on the speed and accuracy with which they answer specific questions;
C. Online contestants are required to pay an entry fee to play in the game;
D. Each round of the game has an entry fee, and players' returns are based on their performance as well as the size of entry fee pot that is redistributed amongst the players;
E. In order to maximize continued interest and participation of viewers and online players, players win/lose a certain sum of money in every round, but are not excluded from participating in subsequent rounds; and
F. Part of the prize money is distributed at the end of each round while part of it accrues towards the final round of each episode. The part distributed gets divided between a very large number of players, with all those in the top 10-20 percentile in a round making some gains on the money they “bet” in the round. Quizzing is a game of skill, and online betting on games of skill is legal in the US as opposed to online betting on games of chance, which constitutes online gambling and are illegal.

As the game progresses, gains of the top performers become disproportionately high, which keeps the excitement level high and creates “stars” of the game. The rules above can be further refined to make the game play more exciting.

Sources of revenue include advertising to television viewers, rich media based advertising to online contestants, and a share of the entry fee pot.

The game design and technology is designed to eliminate all major problems likely to be encountered any game in this genre, such as poor quality of streamed video, mismatch of players' response times due to different latency rates, and cheating by online contestants. All these problems can be solved by giving a unique or different set of questions to various players, and pre-downloading the individual questions spoken by the host to players' computers ahead of the game by using the download technology of companies such as Kontiki or other download technologies. As the questions are being pre-downloaded to individual computers, each of them will receive a different sent of questions than most others, minimizing the chances of cheating.

Another potential solution could be to incorporate known technology that allows people to watch their television on computer screens. In this solution, the present invention could potentially take the video input for an online player from his/her TV, whereas the rest of the content (e.g. a question answer screen) could come from servers through TCP/IP protocol.

A third potential solution would be to create a game using interactive television technology, where people play this game on their televisions rather than computers.

The game lends itself very well to the syndication phase, where online contestants can still play along the broadcast of original shows for large prizes. In the syndication phase, the reruns can continue to be the glue for an enormously profitable massively multiplayer online game.

Interactive Entertainment Content Alternative Embodiment

The system of the present invention may also make the content adaptive to the user. This is used to create powerful entertainment content. Entertainment content such as movies and television- or computer-based series can be developed such that their stories get influenced by the user's actions. While this concept has been partially achieved via animated content in the case of video games, it is a novel concept in the area of “live action” content where the stories revolve around real life content.

The user's role in such content could go way beyond being an observer who is performing peripheral actions such as looking for clues—the user could have a role in the story itself. In this embodiment, the pre-recorded content files would be a part of the system, and then the user's actions would determine which files get “played” as the user consumes the content. This could be used to create many unique experiences for the users including experiences where the users feel that:
A. Other characters in the story are talking to them by playing AV files where these characters appear to be conversing with the user, and the conversations appearing to be.
B. They can operate a weapon by giving them the ability to pan across the screen using an imaginary weapon's telescope, and giving them the illusion of being able to aim and “shoot” at specific screen areas containing an object or a person, such that the story gets influenced by whether they “shot” their target or not.
C. They can perform a certain action by pressing of a button, keying of a password, etc. which plays a role in the story and influences the direction that the story takes. For example, once they viewer has deciphered a certain clue in the story, they can be given the illusion that they can pass on that clue to other characters in the story via instant messaging, chat, or other means of communication.

This embodiment could be streamed or downloaded over the Internet, as well as offered on DVDs/CD-ROMs. Users could also be given the ability to compete with each other across the Internet or in person in this embodiment.

Overall, this embodiment combines the interactivity of video games with the “reality” of live action content. While the embodiment itself focuses on entertainment, the underlying method is fundamentally similar to the creation of adaptive educational courses mentioned above. The technical framework which will form the basis for this embodiment will again be very similar to the technical framework for the educational content. For example, the AV file where a character in the story says something in response to a specific action by the user will be the equivalent of a teacher explaining to a student why they went wrong in answering a specific question.

Marketing Considerations

One objective of the present invention is to help teachers market their services, something they cannot easily do on their own today. The present invention provides a market place that allows for students to find teachers and teachers to find students.

The present invention ensures a balance between the demand and supply in the instruction market by allowing students to list the areas where they are looking for tuitions and allow teachers to list keywords related to areas in which they can teach people. The present invention will email a profile of students' demands/requests to teachers based on the keywords teachers have entered for their expertise. This way, teachers will get to know which areas have demand from students.

Students will be able to find teachers for courses in any area, either by searching through the courses being offered on our website, or by their demand being conveyed to teachers that specialize in the area where students are looking for help. This method works as follows. Students will be able to leave keywords on courses that they are looking for, and based on an intelligent match with keywords on a teacher's expertise entered by teachers themselves previously, the system will be able to send emails to teachers informing them of the student demand. For example, a teacher could know that in the last 24 hrs, 50 students searched for a course in their area of expertise. Students will have the option of also allowing the teacher to contact them individually or as a part of the group of students that could be interested in the teacher's expertise. The teacher can write back to them and they can have a one on one session or the teacher can structure the course around the needs of a group of students.

Additionally, auction sites such as eBay can be a channel for marketing, where teachers conduct Dutch auctions to receive a fair price for their expertise, time and services.

The present invention will also help teachers market their services by creating automated and/or manually entered listings for them on internet marketing services such as Google Adwords and Yahoo Overture. The ads on these services will still show the system's web address to the user but the user will be directly taken to the specific teacher's course or profile on the system's website for which the ad was displayed on any of these services. Thus the whole teacher community on the system's website benefits from the enhanced brand awareness of the system, while the specific teacher whose ad was displayed also benefits because those who click on the ad are directly taken to their course or profile on the system's website. This method greatly reduces and can even eliminate a teacher's risk in making a marketing investment.

Additional system marketing efforts could include direct mailers on teachers' behalf and/or a high level marketing campaign based around the system, which all teachers teaching using the system would benefit from.

In order to further popularize the service, the system can guarantee performance improvement for students. In case of GMAT, GRE and other test preps, this could include guarantee of a certain level of performance improvement, based on the score of the student in a test administered by us before the beginning of the course. The system could even say it will not charge the student's card or account unless the students' results are as promised or refund the charges if the student's performance fell below the guaranteed level of improvement. The performance improvement guaranteed could depend on what the students scored in the test that the system administered to them before the beginning of the course.

Additionally, accreditation and associations with existing schools and universities can be explored.

It is appreciated that the relationships for the parts of the invention, to include variation in database and subsystem configuration to detach them for each other and provide the possibilities to deploy the system in different locations and under different authorities with division of labor, are deemed readily apparent and obvious to one of ordinary skill in the art, and all equivalent relationships to those illustrated in the drawings and described in the above description are intended to be encompassed by the present invention.

In addition, other areas of art may benefit from this method and adjustments to the design are anticipated. Thus, the scope of the invention should be determined by the appended claims and their legal equivalents, rather than by the examples given.

1. A system for delivering distance learning comprising:
a standard website interface;
a transaction management component providing means for
activating the system and allowing access once credit card information is entered;
billing an account for the lectures as well as tutoring sessions; and
for minors, a providing a parent with their own login that is linked to the minor's account with academic performance and progress visible to them; and emailed a monthly statement for all transactions;
a course workspace;
a course server that coordinates all elements of a lecture, including host video feeds, other video feeds, quiz questions, quiz responses, email server, and advertising feeds;
three kinds of roles of users interacting with the central server; Students, Tutors, Administrators;
an E-commerce component providing means for selling course material;
an interface that coordinates the dispatch and receipt of audio-video feeds; and
a white boarding capture mechanism for record what the teacher writes on an interactive whiteboard or a tablet PC.

2. (canceled)

3. The system for delivering distance learning of claim 1 wherein
the software for individual users is either a downloadable or a browser based client software that interacts with the course server; and further comprising
a client application with a plurality of sections that replicates the audio and visual aspects of a traditional classroom by providing:
(a) a video feed for providing the student with an audio and visual classroom experience of the teacher teaching in a classroom;
(b) an electronic whiteboard that replicates what a teacher would write on a traditional blackboard;
(c) synchronization between the audio-video feed and white board; and
(d) one or more secondary window.

4. The system for delivering distance learning of claim 1 further comprising:
a client application as means for enabling discourse of lectures, obtain feedback during live lectures;
a pre-scheduled broadcast time for live lectures;
providing access to any lectures from archives on the course server that may be paused, fast forward or rewound;
providing means to mark points that can later be accessed or replayed; and
commercials appear in the video feed section during breaks in the lectures.

5. The system for delivering distance learning of claim 4 further wherein:
the video feed and teaching area of the browser are replaced by a quiz whiteboard containing the content for quizzes;
said whiteboard has a two-way communication between the system's servers and students' software in order for them to be able to answer the quiz questions and get feedback;
students submit their answers within a pre-defined period of time;
the software will automatically check students' answers and provides individualized results while comparing them with those in their peer group who have taken that quiz till then;
after the time for a quiz is over and the results are displayed, quiz whiteboard will switch back to the video feed and teaching area where the teacher's notes will again start appearing.

6. The system for delivering distance learning of claim 5 further wherein:
the system is also means for providing a tutoring service where students ask questions to tutors;
said tutors have an interface of their own;
whenever a student is discussing a doubt with a tutor, there will also be a section of the browser where the student will be able to chat with the tutor;
this section remains visible even as the student or tutor toggles back and forth between the tutoring whiteboard and the video feed or teaching area views.

7. (canceled)

8. (canceled)

9. The system for delivering distance learning of claim 1 wherein the course server will:
serve up all elements of a lecture including AV feeds, graphics, questions and possible answers and advertising;
receive all responses and perform all data analyses associated with administering a quiz or assignment;
coordinate all elements of a lecture, including host video feeds, other video feeds, quiz questions, quiz responses, email server, and advertising feeds;
provide all calculations relating to the students' performance; and
serve up all previous lectures and associated content.

10. (canceled)

11. The system for delivering distance learning of claim 1 wherein
a teacher records the AV portion of the course and designs all quizzes, assignments, time schedule and other course content within the central system;
tutors are then available to answer students' specific queries through a combination of white boarding, instant messaging and VoIP communications techniques via the central system; and
students watch the archived lectures at their convenience by connecting to the central system and solve any doubts they have by interacting with tutors via the central system; and
means for student to ac print, or download the teacher's handwritten notes made while conducting the initial recording of the course material.

12. The system for delivering distance learning of claim 11 wherein the teacher has pre-record specific content associated with each of the answer choices of for questions within a quiz.

13. The system for delivering distance learning of claim 12 wherein the teacher records lectures for each section of a specific textbook.

14. The system for delivering distance learning of claim 1 wherein
teachers conduct live telecasts of their lectures based on a defined schedule and answer any student queries themselves during the lectures via the central system;
students ask questions via chat or by speaking through a conventional phone or VoIP mechanism depending on when the teacher allows them to speak during the session;
the teacher answers their question by writing on the whiteboard or on other teaching content being used and explaining further by speaking as the teacher would in an offline classroom; and
the lectures are archived automatically by the central system for replay at a later time.

15. (canceled)

16. (canceled)

17. (canceled)

18. (canceled)

19. (canceled)

20. The system for delivering distance learning of claim 19 wherein when a lecture is viewed in archive mode
the ability to pause an archive lecture at any point and get a question answered by a tutor is available to a student;
for the archived or pre-recorded content offered by the teachers, complete interactivity at all times is provide by using tutors trained on the courses;
a combination of a tutoring whiteboard and instant messaging, chat, VoIP, regular phone services are available where the tutoring whiteboard replaces the video feed as well as the teaching whiteboard section of the screen;
the tutoring whiteboard is visible to both the student and the tutor at the same time; and
either the tutor or the student can switch hack individually or in synch with each other to the video feed, or teaching whiteboard and watch them and then toggle hack to the tutoring whiteboard.

21. The system for delivering distance learning of claim 21 wherein students can stop, pause, and start a live lecture.

22. The system for delivering distance learning of claim 19 wherein one secondary window is used to provide chat and instant messaging services, while a second secondary window is a control panel where students can access additional features of the system such as toggling between different visual content.

23. (canceled)

24. The system for delivering distance learning of claim 1 wherein
the authoring and distribution of educational content is adaptive to the user's academic comprehension and performance;
means to diagnose and strengthen the students' areas of weaknesses in any subject by focusing them on appropriate content;
said content automatically chosen from a universal content database;
said content database developed on the basis of a structured skill and sub-skill hierarchy, repeating the content as necessary;
means for replicating the classroom environment with audio visual display and a synchronized white board;
means for offering interactivity with live tutors available to answer questions on archived content; and
reporting means for keeping the parents informed of the students' progress.

25. The system for delivering distance learning of claim 9 wherein
the system used for authoring and offering the educational services can be used for game shows by replacing the audio visual content; and
the system for offering educational quizzes can used to manage a quiz show's question-answers segment;
thereby providing means for producing and distributing game shows that allow viewer participation via the Internet in very large numbers.

26. A system for producing and distributing interactive movies, wherein
the viewer plays a role in the storyline as opposed to just viewing it or peripherally looking for clues;
the story will impacted in real-time by viewer actions; and
means for providing a backend collection of a universal set of files, only a selective set of which are played.

27. The system for delivering distance learning of claim 11 wherein the system control course content by providing means for recoding the courses while using teachers who design and deliver the course content, said teachers write on the electronic whiteboards and speak, and an e-learning-based course is created in real time.

28. The system for delivering distance learning of claim 14 wherein the system control course content by providing means for recoding the courses while using teachers who design and deliver the course content, said teachers write on the electronic whiteboards and speak, and an e-learning-based course is created in real time.

29. The system for delivering distance learning of claim 11 wherein
the central server acts as an intermediary, taking a share of the revenues generated by the teachers' offering courses;
teachers can offer courses or tutoring services in any area they wish;
students can sign up for any courses or tutoring services they want; and
students can rate teachers.

30. The system for delivering distance learning of claim 14 wherein
the central server acts as an intermediary, taking a share of the revenues generated by the teachers' offering courses;
teachers can offer courses or tutoring services in any area they wish;
students can sign up for any courses or tutoring services they want; and
students can rate teachers.
